(19) United States
(12) Patent Application Publication
(10) Pub. No.: US 2026/0124942 A1
(43) Pub. Date: May 7, 2026

(54) BRACKET CONFIGURED TO CONNECT TO CHARGING UNIT AND INCLUDING CHARGING CABLE HOLDER

(71) Applicant: Ford Global Technologies, LLC, Dearborn, MI (US)

(72) Inventors: Amit M. Patankar, Farmington Hills, MI (US); Christopher Gerard Coakley, White Lake, MI (US)

(21) Appl. No.: 18/935,869

(22) Filed: Nov. 4, 2024

(51) Int. Cl. B60L 53/30; H02G 3/04; H02J 7/00; B60L 53/18

(52) U.S. Cl. CPC B60L 53/30; H02G 3/0456; H02J 7/70; B60L 53/18

(57) ABSTRACT

An assembly for use in mounting electric vehicle supply equipment (EVSE) may include a bracket configured to be mounted to a wall. The bracket may be configured to establish a connection with a charging unit, and the bracket may include a charging cable holder.

### TECHNICAL FIELD

This disclosure relates generally to an assembly for use in mounting electric vehicle supply equipment (EVSE), and in particular relates to a bracket configured to connect to a charging unit. The bracket further includes a charging cable holder.

### BACKGROUND

Electrified vehicles differ from conventional motor vehicles because they are selectively driven by one or more traction battery pack powered electric machines. The electric machines can propel the electrified vehicles instead of, or in combination with, an internal combustion engine. Some electrified vehicles, such as plug-in hybrid electric vehicles (PHEVs) and battery electric vehicles (BEVs), include a charge port assembly that is connectable to a plug of electric vehicle supply equipment (EVSE) assembly for charging the traction battery pack.

### SUMMARY

In some aspects, the techniques described herein relate to an assembly, including: a charging unit including a charging cable projecting therefrom; and a bracket configured to be mounted to a wall, wherein the bracket is further configured to establish a connection with the charging unit, and wherein the bracket includes a charging cable holder.

In some aspects, the techniques described herein relate to an assembly, wherein the bracket is configured to establish a tool-free connection with the charging unit.

In some aspects, the techniques described herein relate to an assembly, wherein the bracket is configured to establish a snap-fit connection with the charging unit.

In some aspects, the techniques described herein relate to an assembly, wherein the bracket includes at least one deflectable tab configured to selectively interface with the charging unit to establish the snap-fit connection.

In some aspects, the techniques described herein relate to an assembly, wherein an exterior housing of the charging unit includes a perimeter rim, and wherein the at least one deflectable tab is configured to interface with the perimeter rim to establish the snap-fit connection.

In some aspects, the techniques described herein relate to an assembly, wherein: the bracket is configured to connect to the charging unit at a first connection location and a second connection location, and the second connection location is spaced-apart from the first connection location.

In some aspects, the techniques described herein relate to an assembly, wherein: the bracket and charging unit are configured to engage at the first connection location without engaging at the second connection location such that the charging unit is able to pivot relative to the bracket about the first connection location, and the bracket and charging unit are configured such that pivoting of the charging unit about the first connection location causes the charging unit to engage the at least one deflectable tab and establish the snap-fit connection between the charging unit and the bracket.

In some aspects, the techniques described herein relate to an assembly, wherein the first connection location is vertically below the second connection location.

In some aspects, the techniques described herein relate to an assembly, wherein the bracket includes two deflectable tabs at the second connection location.

In some aspects, the techniques described herein relate to an assembly, wherein the bracket includes at least one tab at the first connection location configured to engage with the charging unit such that the charging unit is able to pivot relative to the first connection location.

In some aspects, the techniques described herein relate to an assembly, wherein, between the first connection location and the second connection location, the bracket includes a first recess configured to receive a portion of the charging unit.

In some aspects, the techniques described herein relate to an assembly, wherein, within the first recess, the bracket includes a second recess including through-openings configured to permit fasteners to pass therethrough to connect the bracket to the wall.

In some aspects, the techniques described herein relate to an assembly, further including a cover configured to cover the second recess, and configured to sit substantially flush with the first recess when covering the second recess.

In some aspects, the techniques described herein relate to an assembly, wherein: the bracket includes a main wall configured to lie in a plane substantially parallel to the wall when the bracket is connected to the wall, the charging cable holder includes a first wall projecting outward from the main wall, and the charging cable holder includes a second wall projecting from the first wall.

In some aspects, the techniques described herein relate to an assembly, wherein the second wall includes an outer face including a recess configured to interface with a plug provided at an end of the charging cable.

In some aspects, the techniques described herein relate to an assembly, wherein the first and second walls of the charging cable holder establish a hook configured to hold a plurality of coils of the charging cable.

In some aspects, the techniques described herein relate to an assembly, wherein the portion of the bracket configured to establish the connection with the charging unit is integrally formed with the portion of the bracket providing the charging cable holder.

In some aspects, the techniques described herein relate to an assembly, wherein an exterior housing of the charging unit includes a perimeter recess configured to receive a plurality of coils of the charging cable.

In some aspects, the techniques described herein relate to a bracket for use with electric vehicle supply equipment (EVSE), including: a first portion configured to establish a connection with a wall, and further configured to establish a connection with a charging unit, and a second portion establishing a charging cable holder.

In some aspects, the techniques described herein relate to a method, including: establishing a snap-fit connection between a charging unit and a bracket, wherein the bracket is connected to a wall, and wherein the bracket includes a charging cable holder.

### BRIEF DESCRIPTION OF THE DRAWINGS

FIG. 1 illustrates a portion of an example electrified vehicle and an example charging assembly.

FIG. 2 illustrates an example assembly, including a bracket, connected to a charging unit.

FIG. 3 is an exploded view of the example assembly.

FIG. 4 illustrates a charging unit connected to the bracket at a first connection location only.

FIG. 5 illustrates the charging unit connected to the bracket at first and second connection locations such that a snap-fit connection is established.

FIG. 6 illustrates an example aspect of this disclosure in which the charging cable holder includes a recess configured to receive a charging plug.

FIG. 7 illustrates an example aspect of this disclosure in which the charging unit includes a perimeter recess.

### DETAILED DESCRIPTION

This disclosure relates generally to an assembly for use in mounting electric vehicle supply equipment (EVSE), and in particular relates to a bracket configured to connect to a charging unit. The bracket further includes a charging cable holder. Among other benefits, which will be appreciated from the below description, this disclosure provides a robust wall-mounted bracket and charge cabling holder. The arrangement of the charging cable holder enables the charging cable to be supported in a tidy, orderly manner. The disclosure also reduces part count, by integrating the charging cable holder into the wall-mounted bracket. The disclosure also increases ease of assembly. These and other benefits will be appreciated from the following written description.

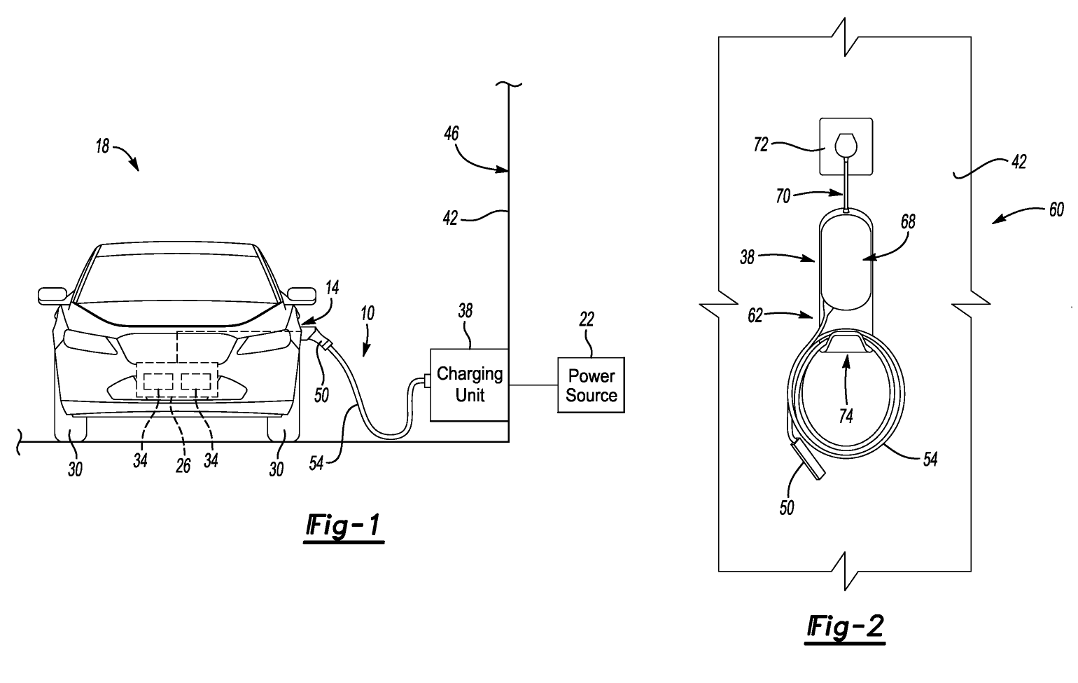

FIG. 1 illustrates an exemplary charging assembly 10 operatively coupled to a charge port 14 of an electrified vehicle 18. The charging assembly 10 is used to transfer energy to the electrified vehicle 18 from a power source 22, which is, in this example, a grid power source. However, in other examples, the power source 22 could be another source of power such as another vehicle, a stand-by battery, a renewable energy source, etc.

The charging assembly 10 can be used at a user’s home, a commercial building, a parking garage, a charging station, or another type of structure that is capable of transferring energy to the electrified vehicle 18.

In the exemplary embodiment, the electrified vehicle 18 is a plug-in type electrified vehicle (e.g., a plug-in hybrid electric vehicle PHEV) or a battery electric vehicle (BEV). The electrified vehicle 18 includes a traction battery pack 26 that is part of an electrified powertrain capable of applying a torque from an electric machine (e.g., an electric motor) for driving drive wheels 30 of the electrified vehicle 18. Therefore, the electrified powertrain of the electrified vehicle 18 can electrically propel the drive wheels 30 either with or without the assistance of an internal combustion engine.

The charging assembly 10 is shown relative to an electrified vehicle 18 that is a sedan. However, this disclosure could be applicable to any type of vehicle. For example, the electrified vehicle 18 could be configured as a truck, van, SUV, etc.

The traction battery pack 26 is configured as a high voltage traction battery pack that includes a plurality of battery arrays 34 (i.e., battery assemblies or groupings of individual battery cells) capable of outputting electrical power to one or more electric machines of the electrified vehicle 18. Other types of energy storage devices and/or output devices may be used to electrically power the electrified vehicle 18.

The electrified vehicle 18 interfaces with the power source 22 through the charging assembly 10 to facilitate energy transfer. In an embodiment, the charging assembly 10 may be referred to as electric vehicle supply equipment (EVSE). The charging assembly 10 can connect to the power source 22 through a charging unit 38, or wall box, of the EVSE, which can be mounted to a wall 42 of a structure 46, such as a wall of a garage. The charging assembly 10 can then be used to transfer energy to the electrified vehicle 18. In some examples, the charging assembly 10 could be a bi-directional charging assembly capable of transferring energy from the electrified vehicle 18 back through the charging unit 38 to the power source 22, or to power loads of the structure 46.

In addition to the charging unit 38, the charging assembly 10 includes a charging cable 54 projecting from the charging unit, and a charging plug 50 disposed at an end of the charging cable 54 opposite the charging unit 38. The charging plug 50 is configured to operably couple to the charge port 14 of the electrified vehicle 18. The charging cable 54 connects the charging plug 50 to the power source 22 via the charging unit 38, in this example. The charging unit 38 can be considered a power source as the charging unit 38 is electrically coupled to the power source 22.

Typically, a user moves the charging plug 50 from a position where the charging plug 50 is not coupled to the charge port 14 to an engaged position where the charging plug 50 is operably coupled to the charge port 14. When the charging plug 50 is in the engaged position the electrified vehicle 18 is often referred to as being on plug.

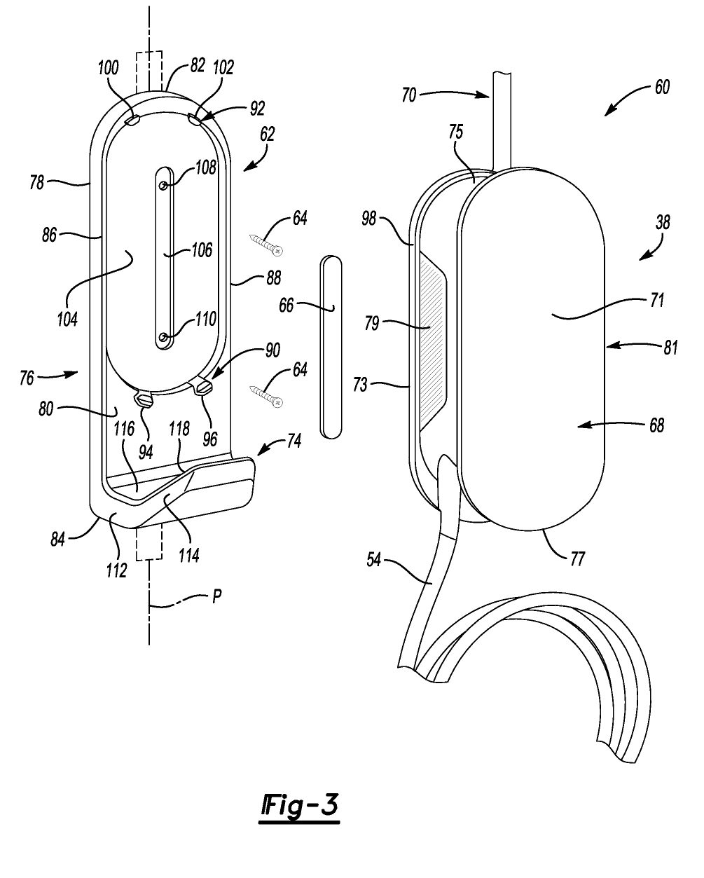

FIGS. 2 and 3 illustrate an assembly 60 for use in mounting some components of the charging assembly 10. The assembly 60 includes a bracket 62, fasteners 64, and a cover 66 in this example. Various components of the charging assembly 10 may be considered parts of the assembly 60. For example, the charging unit 38, charging cable 54, and charging plug 50 may be considered parts of the assembly 60.

The charging unit 38 includes an exterior housing 68. The exterior housing 68 includes a front wall 71 spaced-apart from a rear wall 73. The front wall 71 may include one or more displays configured to display information to a user, and/or one or more buttons configured to control operation of the charging unit 38.

The front and rear walls 71, 73 are spaced-apart from one another by a top wall 75, a bottom wall 77 vertically spaced-apart from the top wall 75, and first and second side walls 79, 81, which are arranged on generally opposite sides of the charging unit 38. The terms front, rear, top, bottom, and side are used relative to the orientation of the charging unit 38 in FIGS. 2 and 3. The walls 75, 77, 79, and 81 are configured such that the exterior housing 68 exhibits a substantial stadium-shape. This disclosure extends to other configurations and shapes of the exterior housing, however.

Adjacent the top wall 75, the charging unit 38 includes a supply cable 70 projecting therefrom. The supply cable 70 is configured to connect the charging unit 38 to the power source 22 via an electrical box 72 in the wall 42, in this example. Adjacent an intersection of the side wall 79 and bottom wall 77, the charging unit includes the charging cable 54 projecting therefrom. The supply cable 70 and charging cable 54 may be detachable from the exterior housing 68.

The bracket 62 is configured to be mounted to the wall 42. In particular the bracket 62 is configured to be rigidly mounted to the wall 42 via fasteners 64. The bracket 62 is further configured to establish a connection with the charging unit 38, and the bracket 62 includes a charging cable holder 74 configured to hold the charging cable 54. The charging cable holder 74 holds the charging cable 54 at a convenient height for the user. Because the bracket 62 includes the charging cable holder 74, part count is reduced and ease of assembly is increased.

The bracket 62 includes a main wall 76 configured to lie in a plane P substantially parallel to the wall 42 when the bracket 62 is connected to the wall 42. The main wall 76 includes a rear face 78 and a front face 80. The rear face 78 faces toward the wall 42 when the bracket 62 is connected to the wall 42. The main wall 76 includes a top wall 82, a bottom wall 84 vertically spaced-apart from the top wall 82, and side walls 86, 88, which are arranged on generally opposite sides of the bracket 62. In general, the charging cable holder 74 is arranged adjacent the bottom wall 84, and the bracket 62 is configured to connected to the charging unit 38 above the charging cable holder 74.

An example connection between the bracket 62 and the charging unit 38 will now be described. The bracket 62 is configured to connect to the charging unit 38 at two general locations. The bracket 62 is configured to connect to the charging unit 38 at a first connection location 90 and a second connection location 92 spaced-apart from the first connection location 90. In particular, in this example, the second connection location 92 is vertically above the first connection location 90. The first connection location 90 is spaced-apart vertically above the charging cable holder 74 in this example. The first and second connection locations 90, 92 could be laterally spaced-apart in other examples.

Within the first connection location 90 the bracket 62 includes at least one tab configured to engage with the charging unit 38 such that the charging unit 38 is able to pivot relative to the bracket 62 about the first connection location 90. Within the first connection location 90, the bracket 62 includes two tabs 94, 96 in this example. While two tabs 94, 96 are shown, there could be one or more tabs 94, 96. In general, the tabs 94, 96 are configured to interface with a rim 98 provided about an entire outer perimeter of the charging unit 38 adjacent the rear wall 73. The tabs 94, 96 are L-shaped such that the tabs 94, 96 restrict laterally outward movement of the charging unit 38 away from the bracket 62 when the rim 98 interfaces with tabs 94, 96. The tabs 94, 96 may be deflectable, such as when brought into engagement with the rim 98.

Within the second connection location 92 the bracket 62 includes at least one tab configured to engage with the charging unit 38 to establish a snap-fit connection with the charging unit 38. Within the second connection location 92, the bracket 62 includes two tabs 100, 102, in this example. While two tabs 100, 102 are shown, there could be one or more tabs within the second connection location 92. In general, the tabs 100, 102 are generally L-shaped, and are configured to deflect when initially brought into contact with the rim 98, and such that continued deflection of the tabs 100, 102 permits the tabs 100, 102 to engage the rim 98 so as to establish a snap-fit connection with the rim 98. While a snap-fit connection is described, this disclosure extends to other tool-free connections between the bracket 62 and the charging unit 38. The charging unit 38 can be removed from the bracket 62 by undoing the snap-fit connection manually, without the use of tools.

The first connection location 90 generally corresponds to a location of a bottom wall 77, and the second connection location 92 generally corresponds to a location of a top wall 75, relative to when the charging unit 38 is connected to the bracket 62. Between the first and second connection locations 90, 92, the front face 80 includes a first recess 104, recessed relative to the remainder of the front face 80, configured to receive a portion, namely at least a portion of the rim 98 and at least a portion of the rear wall 73, of the charging unit 38 when the charging unit 38 is connected to the bracket 62. The first recess 104 is shaped to correspond to the shape of the exterior housing 68. In this example, the first recess 104 is substantially stadium-shaped.

In this example, within first recess 104, the bracket 62 includes a second recess 106. Within the second recess 106, the bracket 62 includes through-openings 108, 110 configured to permit fasteners 64 to pass therethrough to connect the bracket 62 to the wall 42. The cover 66 is configured to cover the second recess 106, and the fasteners 64, if present. The cover 66 is configured to sit substantially flush with the first recess 104 when engaged with the second recess 106, in an example. In other examples, the cover 66 is recessed below the first recess 104, or is not present.

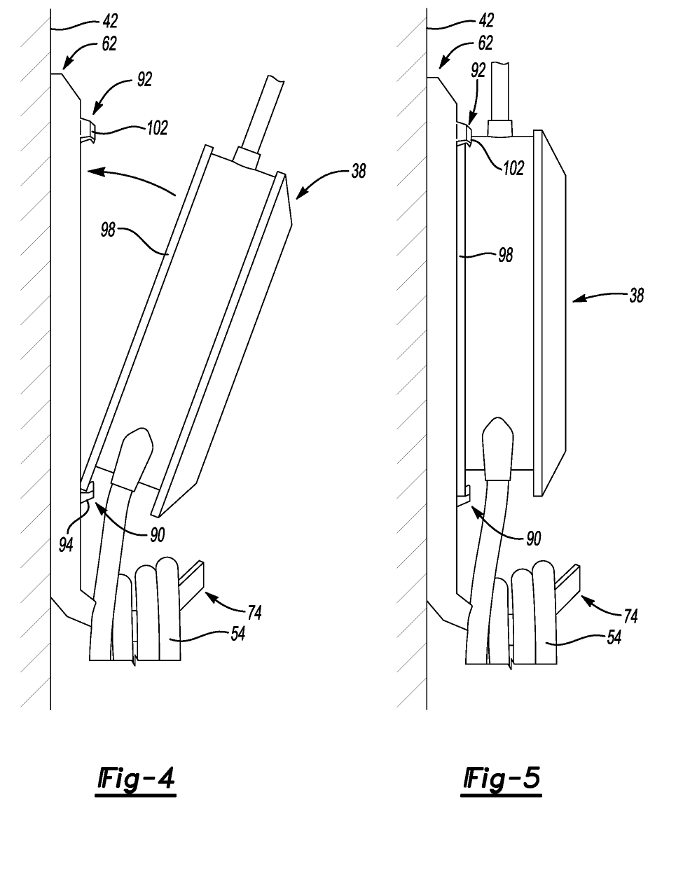

FIGS. 4 and 5 illustrate an example sequence for connecting the charging unit 38 to the bracket 62. As shown in FIG. 4, the rim 98 is interfacing with the tabs 94, 96 of the first connection location 90 such that the charging unit 38 is rotatable about the first connection location 90. As the user pivots the charging unit 38 toward the bracket 62 and wall 42 about the first connection location 90, the rim 98 interfaces with the tabs 100, 102 of the second connection location 92 to establish a snap-fit connection, as generally shown in FIG. 5. During this connection process, the charging cable 54 may be supported on the charging cable holder 74. In an alternative sequence, the rim 98 of the charging unit 38 first interfaces with tabs 100, 102 of the second connection location 92, and the charging unit 38 is pivoted about the second connection location 92 such that the rim 98 interfaces with the tabs 94, 96 of the first connection location 90 to establish a snap-fit connection.

With reference back to FIG. 3, the charging cable holder 74 includes a first wall 112 projecting outward from the main wall 76 at a location adjacent the bottom wall 84. The charging cable holder 74 further includes a second wall 114 projecting from an end of the first wall 112. The first and second walls 112, 114, and in particular inner surfaces 116, 118 thereof, establish a hook for holding at least one coil of the charging cable 54. In some examples, first wall 112 may include one or more segments, with those segments including lateral and vertical vector components. In other examples, first wall 112 projects substantially perpendicularly relative to the main wall 76.

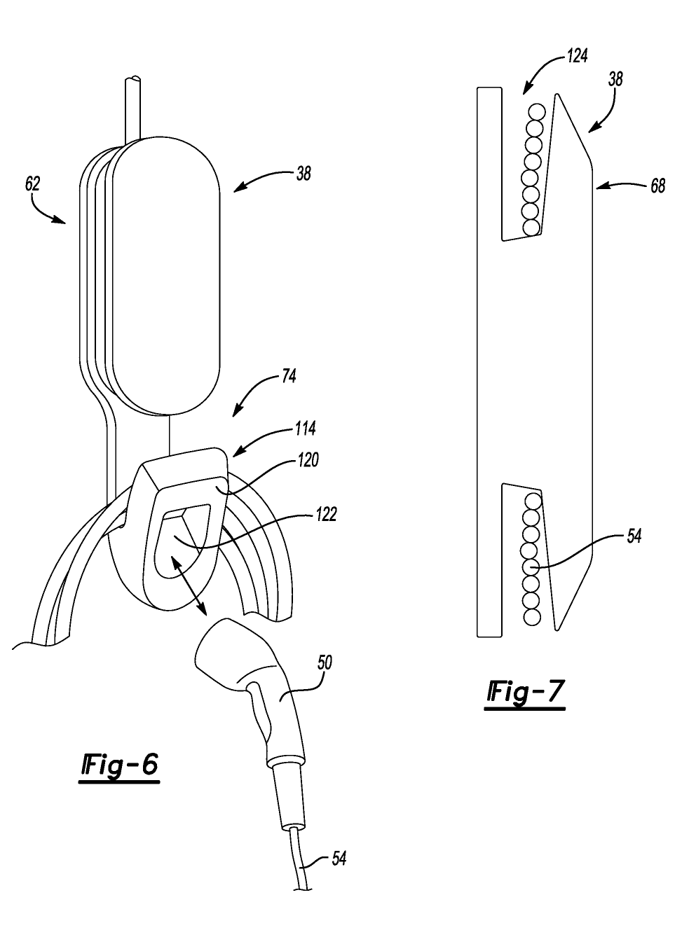

In an embodiment of this disclosure, shown in FIG. 6, an outer face 120 of the second wall 114 includes a recess 122 configured to interface with the charging plug 50. The recess 122 may include a socket sized and shaped similar to a charging port on an electrified vehicle that is able to interface with the charging plug 50. In that example, the recess 122 is not connected to electrical power, however. The recess 122 may be able to selectively hold the charging plug 50 using detents or other similar structures. The charging plug 50 may interface with the recess 122 while the charging cable 54 is held on the charging cable holder 74. When the charging plug 50 is held in the recess 122, a user is able to manually remove the charging plug 50 from the recess 122 by simply pulling on the charging plug 50.

In this disclosure, the portions of the bracket 62 configured to establish the connection with the charging unit 38 are integrally formed with the portions of the bracket 62 providing the charging cable holder 74. In a specific embodiment, with the exception of the cover 66, the bracket 62 is integrally formed as a one-piece structure.

In another aspect of this disclosure, shown in FIG. 7, the exterior housing 68 of the charging unit includes a perimeter recess 124 configured to receive a plurality of coils of the charging cable 54 when the charging unit 38 is detached from the bracket 62. The perimeter recess 124 facilitates ease of transporting the charging unit 38. The charging unit 38 is able to connect to the bracket 62 even when the cable 54 is coiled about the perimeter recess 124.

It should be understood that terms such as “about,” “substantially,” and “generally” are not intended to be boundaryless terms, and should be interpreted consistent with the way one skilled in the art would interpret those terms. Unless otherwise specified, directional terms are not intended to be limiting.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. An assembly, comprising:
a charging unit including a charging cable projecting therefrom; and
a bracket configured to be mounted to a wall, wherein the bracket is further configured to establish a connection with the charging unit, and wherein the bracket includes a charging cable holder.

2. The assembly as recited in claim 1, wherein the bracket is configured to establish a tool-free connection with the charging unit.

3. The assembly as recited in claim 2, wherein the bracket is configured to establish a snap-fit connection with the charging unit.

4. The assembly as recited in claim 3, wherein the bracket includes at least one deflectable tab configured to selectively interface with the charging unit to establish the snap-fit connection.

5. The assembly as recited in claim 4, wherein an exterior housing of the charging unit includes a perimeter rim, and wherein the at least one deflectable tab is configured to interface with the perimeter rim to establish the snap-fit connection.

6. The assembly as recited in claim 4, wherein:
the bracket is configured to connect to the charging unit at a first connection location and a second connection location, and
the second connection location is spaced-apart from the first connection location.

7. The assembly as recited in claim 6, wherein:
the bracket and charging unit are configured to engage at the first connection location without engaging at the second connection location such that the charging unit is able to pivot relative to the bracket about the first connection location, and
the bracket and charging unit are configured such that pivoting of the charging unit about the first connection location causes the charging unit to engage the at least one deflectable tab and establish the snap-fit connection between the charging unit and the bracket.

8. The assembly as recited in claim 7, wherein the first connection location is vertically below the second connection location.

9. The assembly as recited in claim 7, wherein the bracket includes two deflectable tabs at the second connection location.

10. The assembly as recited in claim 7, wherein the bracket includes at least one tab at the first connection location configured to engage with the charging unit such that the charging unit is able to pivot relative to the first connection location.

11. The assembly as recited in claim 7, wherein, between the first connection location and the second connection location, the bracket includes a first recess configured to receive a portion of the charging unit.

12. The assembly as recited in claim 11, wherein, within the first recess, the bracket includes a second recess including through-openings configured to permit fasteners to pass therethrough to connect the bracket to the wall.

13. The assembly as recited in claim 12, further comprising a cover configured to cover the second recess, and configured to sit substantially flush with the first recess when covering the second recess.

14. The assembly as recited in claim 1, wherein:
the bracket includes a main wall configured to lie in a plane substantially parallel to the wall when the bracket is connected to the wall,
the charging cable holder includes a first wall projecting outward from the main wall, and
the charging cable holder includes a second wall projecting from the first wall.

15. The assembly as recited in claim 14, wherein the second wall includes an outer face including a recess configured to interface with a plug provided at an end of the charging cable.

16. The assembly as recited in claim 14, wherein the first and second walls of the charging cable holder establish a hook configured to hold a plurality of coils of the charging cable.

17. The assembly as recited in claim 1, wherein the portion of the bracket configured to establish the connection with the charging unit is integrally formed with the portion of the bracket providing the charging cable holder.

18. The assembly as recited in claim 1, wherein an exterior housing of the charging unit includes a perimeter recess configured to receive a plurality of coils of the charging cable.

19. A bracket for use with electric vehicle supply equipment (EVSE), comprising:
a first portion configured to establish a connection with a wall, and further configured to establish a connection with a charging unit, and
a second portion establishing a charging cable holder.

20. A method, comprising:
establishing a snap-fit connection between a charging unit and a bracket, wherein the bracket is connected to a wall, and wherein the bracket comprises a charging cable holder.
